(19) United States
(12) Patent Application Publication
(10) Pub. No.: US 2010/0215124 A1
(43) Pub. Date: Aug. 26, 2010

(54) APPARATUS AND OPERATING METHOD OF DIGITAL RF RECEIVER IN A WIRELESS COMMUNICATION SYSTEM

(75) Inventors: Jong-Wook Zeong, Seoul (KR); Seon-Ho Hwang, Yongin-si (KR); Won-Suk Choi, Seongnam-si (KR); Han-Gue Park, Seoul (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/711,886

(22) Filed: Feb. 24, 2010

(30) Foreign Application Priority Data
Feb. 24, 2009 (KR) 10-2009-0015152

(51) Int. Cl. H04L 27/00

(52) U.S. Cl. 375/316

(57) ABSTRACT

An apparatus and an operating method of a digital Radio Frequency receiver in a wireless communication system are provided. The digital RF receiver includes a digital signal processor for outputting information of a receive frequency band, and an Analog-Digital Converter for filtering a signal of the receive frequency band from an RF analog signal input and converting the filtered signal to a digital signal.

### PRIORITY

This application claims priority under 35 U.S.C.§119(a) to a Korean patent application filed in the Korean Intellectual Property Office on Feb. 24, 2009 and assigned Serial No. 10-2009-0015152, the contents of which are incorporated herein by reference.

### BACKGROUND OF THE INVENTION

1. Field of the Invention

The present invention relates generally to an apparatus and an operating method of a digital Radio Frequency (RF) receiver in a wireless communication system, and more particularly, to an apparatus and an operating method of a digital RF receiver for supporting a multiband multimode.

2. Description of the Related Art

Due to the recent proliferation of communication techniques, network operators have focused on providing an integrated receiver that can simultaneously support the various communication techniques. Such a receiver is known as a multiband receiver.

A conventional receiver down-converts a Radio Frequency (RF) signal to an Intermediate Frequency (IF) signal through a mixer and then filters the signal at an IF stage, or filters the signal at an RF stage and then down-converts to an IF signal through the mixer.

FIGS. 1 through 4 illustrate conventional receiver structures.

FIGS. 1 and 2 illustrate receiver structures using a sub-sampling. To address noise in the sampling, the receiver of FIG. 1 filters a signal using a plurality of RF Band Pass Filters (BPFs) 100, 102 and 104 before sampling at a sample and hold block 106, and then passes the IF signal through an Analog Digital Converter (ADC) 108 to the IF signal around the baseband. Next, the receiver generates a baseband signal separated to the I channel and the Q channel using digital mixers 110 and 112 and removes unnecessary signals generated when down-converting the signal using digital Low Pass Filters (LPFs) 114 and 116. The receiver of FIG. 2 includes sample and hold blocks 200 and 202, instead of the digital mixers of FIG. 1, in the I channel and the Q channel, respectively, and filters the signal in the respective paths using LPFs 204 and 206, thus reducing a likelihood of aliasing in the baseband.

The two receivers of FIGS. 1 and 2, which do not use an analog mixer, are advantageous in terms of chip area, power consumption, and cost. However, since the ADC is disposed in the IF stage and the RF stage uses the analog filters, these receivers lack flexibility for supporting the multiband multimode.

FIGS. 3 and 4 illustrate conventional receiver structures that increase the digital portion to flexibly support the multiband multimode.

The receivers of FIGS. 3 and 4 convert the signal to a digital signal using ADCs 300, 310, 400 and 410 in the RF stage, separate the signal using separators 306 and 404 into the I channel and the Q channel through LPFs 302, 312, 402 and 412 and decimators 304 and 314 and perform additional digital processes 308 and 406. As to converting the analog signal to the digital signal in the RF stage, the receivers of FIGS. 3 and 4 are advantageous in attaining flexibility for supporting the multiband multimode.

However, since the signal received via antenna is input directly to the ADC after passing through only a Low Noise Amplifier (LNA) and the RF BPF, the receivers of FIGS. 3 and 4 can remove interference signals outside the receive band but cannot remove an in-band blocker (interferer) in the receive band. That is, the in-band blocker in the receive band is still fed into the ADC. Since the ADC needs to receive the wanted signal with the high-power blocker in the in-band at the same time, it is necessary to ensure a sufficient dynamic range and a high sampling rate because of the input of the RF signals.

The power consumption increases as the sampling rate increases with the ADC, and the power consumption virtually doubles as the dynamic range increases by 1 bit (about 6 dB). Hence, in terms of the power consumption of the ADC, the receiver structures of FIGS. 3 and 4 are not technically suitable for a terminal that is limited as to available power.

### SUMMARY OF THE INVENTION

The present invention has been made to address at least the above-described problems and/or disadvantages and to provide at least the advantages described below. Accordingly, an aspect of the present invention is to provide an apparatus and an operating method of a digital RF receiver in a wireless communication system.

Another aspect of the present invention is to provide an apparatus and an operating method of a digital RF receiver for supporting multiband multimode in a wireless communication system.

Another aspect of the present invention is to provide an apparatus and an operating method of a digital RF receiver using an analog-digital converter for digital filtering in a wireless communication system.

Another aspect of the present invention is to provide an apparatus and an operating method of a receiver for reducing power consumption as converting an analog signal to a digital signal in an RF stage in a wireless communication system.

In accordance with the present invention, a digital RF receiver in a wireless communication system includes a digital signal processor for outputting information of a receive frequency band, and an ADC for filtering a signal of the receive frequency band from an RF analog signal input and converting the filtered signal to a digital signal.

In accordance with the present invention, an operating method of a digital RF receiver in a wireless communication system includes outputting information of a receive frequency band, and converting, at an ADC, the filtered signal to a digital signal by filtering a signal of the receive frequency band from an RF analog signal input.

### BRIEF DESCRIPTION OF THE DRAWINGS

The above and other aspects, features and advantages of certain embodiments the present invention will become more apparent from the following detailed description taken in conjunction with the accompanying drawings, in which:

FIGS. 1 through 4 illustrate conventional receiver structures.

FIG. 5 illustrates a receiver structure in a wireless communication system according to the present invention;

FIG. 6 illustrates operations of the receiver in the wireless communication system according to the present invention; and

FIGS. 7A and 7B illustrate the filtering of the receiver in the general wireless communication system.

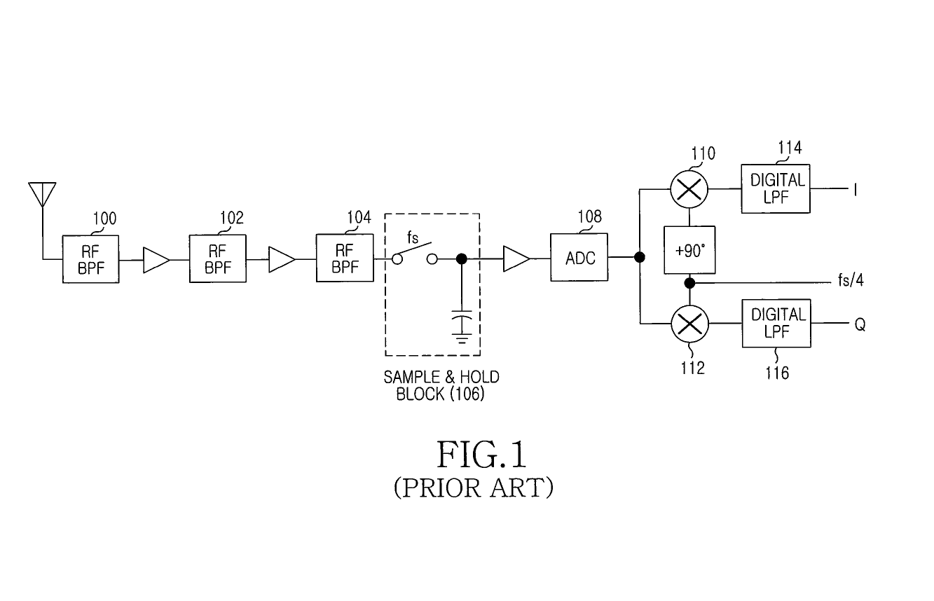

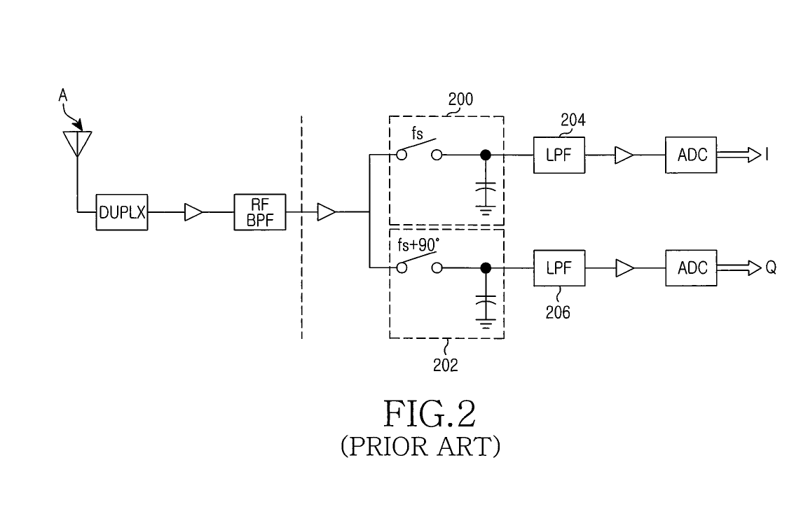

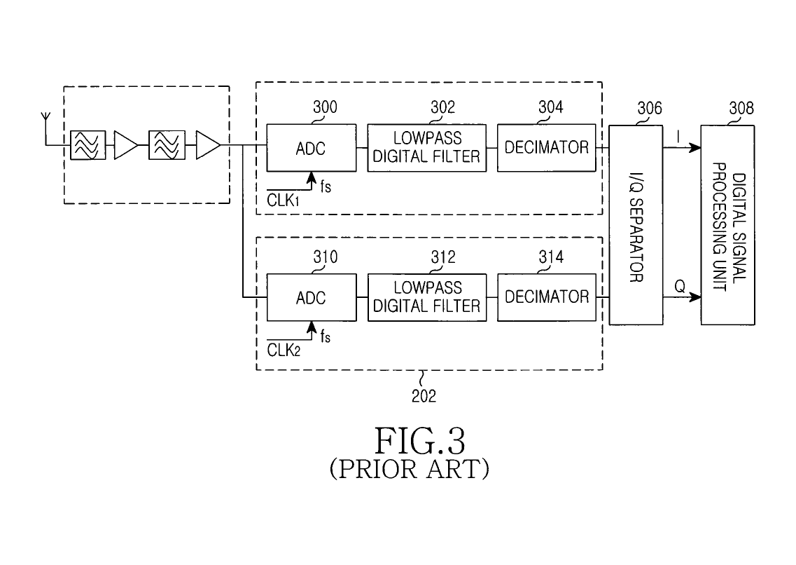

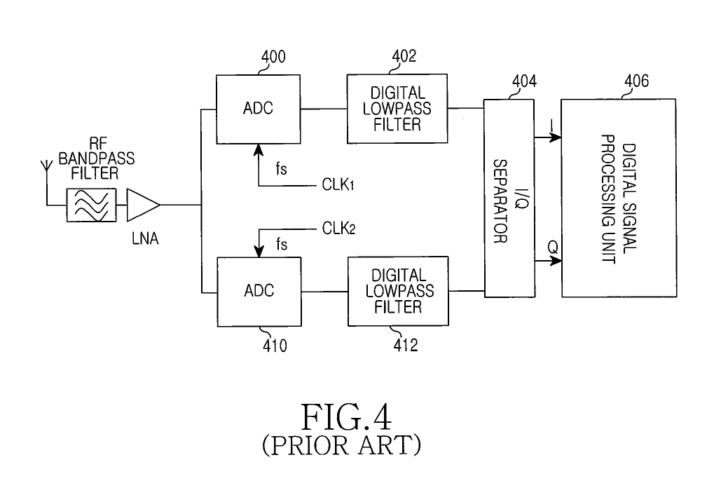

Throughout the drawings, like reference numerals will be understood to refer to like parts, components and structures.

### DETAILED DESCRIPTION OF EMBODIMENTS OF THE INVENTION

Various embodiments of the present invention are described in detail herein below with reference to the accompanying drawings. In the drawings, the same or similar components may be designated by the same or similar reference numerals, although they are illustrated in different drawings. Further, detailed descriptions of constructions or processes known in the art may be omitted for the sake of clarity and conciseness.

Embodiments of the present invention provide an apparatus and an operating method of a digital RF receiver for supporting multiband multimode in a wireless communication system.

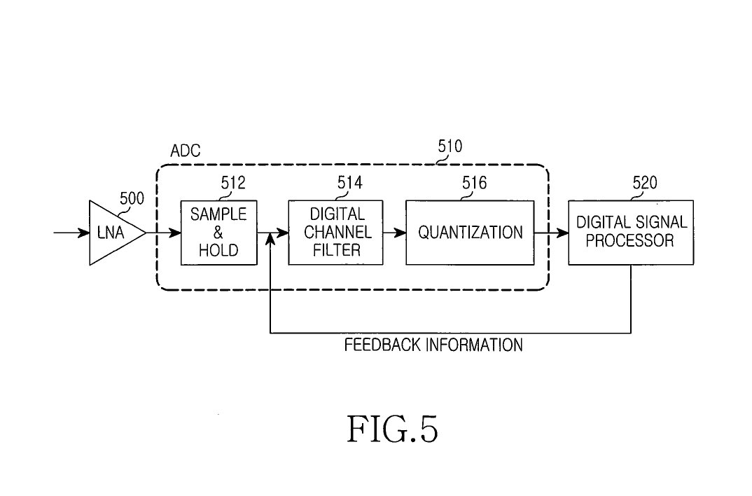

FIG. 5 illustrates a receiver structure in a wireless communication system according to the present invention.

Referring to FIG. 5, the receiver includes an LNA 500, an ADC 510, and a Digital Signal Processor (DSP) 520. The ADC 510 includes a sample and hold unit 512, a digital channel filter 514, and a quantization unit 516.

The LNA 500 low noise amplifies a signal receiver via an antenna (not shown) and outputs the amplified signal to the ADC 510. Herein, the signal fed from the LNA 500 to the ADC 510 belongs to the receive band of the receiver. A signal outside the receive band is removed through the filtering before the input to the ADC 510. That is, the signal received over the antenna (not shown) is filtered to remove the signals outside the receive band and then fed to the LNA 500.

The ADC 510 converts the analog signal received from the LNA 500 to a digital signal and outputs the digital signal to the DSP 520. More specifically, the ADC 510 converts to the digital signal by filtering only signals of the corresponding bandwidth under the control of the DSP 520. The ADC 510 includes the sample and hold unit 512, the digital channel filter 514, and the quantization unit 516 for sampling the input analog signal and quantizing the sampled signal by filtering only signals of the corresponding channel band according to channel band information provided from the DSP 520.

In further detail, using the sample and hold unit 512, the ADC 510 samples the analog signal output from the LNA 500 at intervals, and sustains a constant voltage level of the analog signal to prevent voltage variation of the analog signal and an indefinite output signal while the analog signal is converted to the digital signal.

The digital channel filter 514 filters the signal output from the sample and hold unit 512 according to the channel band information provided from the DSP 520. The digital channel filter 514 passes only the signal corresponding to the channel band among the signal fed from the sample and hold unit 512 and provides the filtered signal to the quantization unit 516. Herein, the digital channel filter 514 represents a discrete time bandpass filter.

The quantization unit 516 receives the filtered signal from the digital channel filter 514 and converts the amplitude of the pulse of the received signal to a digital amount.

The DSP 520 performs additional processing using the digital signal, such as demodulation and decoding of the digital signal output from the ADC 510, and can function as a mixer. In particular, the DSP 520 is already aware of the supportable channel band information of the receiver, and offers the channel band information to support in the receiver to the digital channel filter 514 according to a communication mode.

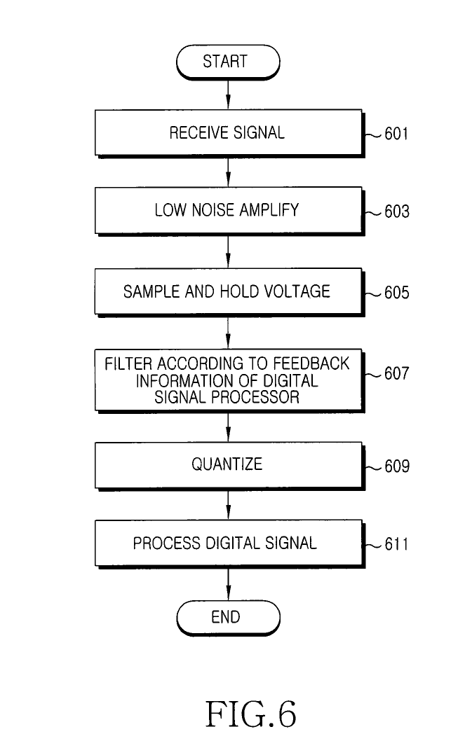

FIG. 6 illustrates operations of the receiver in the wireless communication system according to the present invention.

Referring to FIG. 5, the receiver receives the signal over the antenna in step 601 and low noise amplifies the received signal using the LNA 500 in step 603.

The receiver samples the low noise amplified signal at intervals and fixes the voltage through the sample and hold unit 512 in step 605, and filters the sampled signal according to the feedback information of the DSP 520 through the digital channel filter 514 in step 607. That is, the receiver identifies the frequency band corresponding to the communication mode currently supported through the DSP 520, filters the sampled signal by adjusting the filtering frequency band of the digital channel filter 514 to the identified frequency band, and thus passes only the signals of the identified frequency band. The filtered frequency band can vary according to the communication mode supported by the receiver.

Next, the receiver converts the filtered signal to the digital signal in step 607, quantizes the digital signal in step 609, and then finishes this process.

As such, the receiver forwards the signal fed from the LNA to the ADC in the RF stage, and the ADC converts to the digital signal by filtering only the signals of the frequency band supported by the receiver.

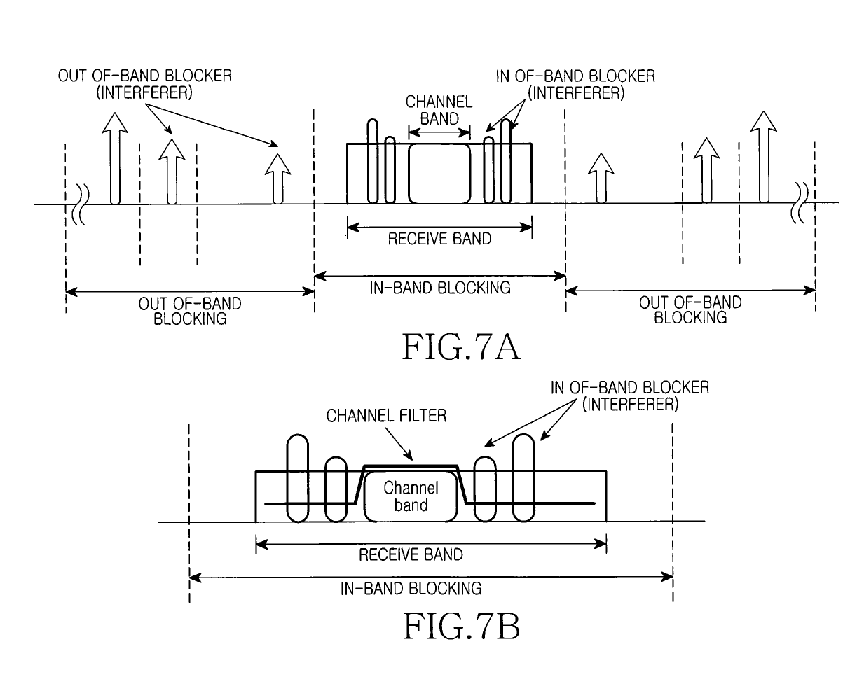

Typically, the receiver filters the received analog signal prior to the conversion to the digital signal so as to extract the signal of a particular channel band including the wanted signal from the signals of the preset receive band. However, the filtering prior to the analog-digital conversion can reduce interference exerted outside the receive band, such as the interference exerted on the external band as illustrated in FIG. 7A, but cannot reduce the interference in the receive band.

When the ADC has a limited dynamic range and a strong in-band interferer in the receive band is input together with the wanted signal, the reception of the wanted signal is desensitized and it becomes difficult to separate the wanted signal from the noise. Accordingly, the ADC requires a greater dynamic range, and the digital receiver must quickly operate since it requires a Gigabyte per second (Gbps) rate level. Yet, when the ADC performs channel filtering after the bandpass and the filtering, the ADC having the small dynamic range can mitigate the interferer inside the receive band as illustrated in FIG. 7B.

The receiver of the wireless communication system converts the analog signal to the digital signal in the RF stage by digital filtering using the ADC. This provides advantages in terms of the chip area and the cost, the flexible support of the multiband multimode, and the reduction in power consumption of the analog-digital conversion.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A digital Radio Frequency (RF) receiver in a wireless communication system, comprising:
a digital signal processor for outputting information of a receive frequency band; and
an Analog-Digital Converter (ADC) for filtering a signal of the receive frequency band from an RF analog signal input and converting the filtered signal to a digital signal.

2. The digital RF receiver of claim 1, wherein the ADC comprises:
a sample and hold unit for sampling the input RF analog signal at intervals and maintaining a constant voltage level;
a digital channel filter for receiving the information of the receive frequency band and filtering the signal of the receive frequency band from the signal sampled at the sample and hold unit; and
a quantization unit for quantizing the filtered signal.

3. The digital RF receiver of claim 1, wherein the digital signal processor stores channel band information per communication mode supported by the receiver, and outputs channel band information corresponding to a current communication mode as the receive frequency band information.

4. The digital RF receiver of claim 1, further comprising:
a Low Noise Amplifier (LNA) for low noise amplifying a signal received via an antenna and providing the amplified signal to the ADC.

5. The digital RF receiver of claim 4, wherein a signal of a frequency band not supported by the receiver is filtered and removed from the signal received via the antenna, and a signal of a frequency band supported by the receiver is provided to the LNA.

6. An operating method of a digital Radio Frequency (RF) receiver in a wireless communication system, comprising:
outputting information of a receive frequency band; and
converting, at an Analog-Digital Converter (ADC), the filtered signal to a digital signal by filtering a signal of the receive frequency band from an RF analog signal input.

7. The operating method of claim 6, wherein the converting to the digital signal comprises:
sampling the RF analog signal at intervals and maintaining a constant voltage level;
filtering the signal of the receive frequency band from the sampled signal; and
quantizing the filtered signal.

8. The operating method of claim 6, wherein the outputting of the information of the receive frequency band comprises:
confirming channel band information corresponding to a current communication mode from channel band information per communication mode supported by the receiver; and
outputting the confirmed channel band information as the receive frequency band information.

9. The operating method of claim 6, further comprising:
low noise amplifying a signal received via an antenna and providing the amplified signal to the ADC.

10. The operating method of claim 9, wherein the low noise amplifying of the signal received via the antenna comprises:
filtering and removing a signal of a frequency band not supported by the receiver from the signal received via the antenna, and amplifying a signal of a frequency band supported by the receiver using a low noise amplifier.
